(19) United States
(12) Patent Application Publication
(10) Pub. No.: US 2011/0206798 A1
(43) Pub. Date: Aug. 25, 2011

(54) FELINE STIMULANT AND METHOD OF MANUFACTURE

(75) Inventor: Valerie Loew, Fullerton, CA (US)

(73) Assignee: MATATABBY, INC., Fullerton, CA (US)

(21) Appl. No.: 12/848,665

(22) Filed: Aug. 2, 2010

Related U.S. Application Data
(63) Continuation-in-part of application No. 12/712,007, filed on Feb. 24, 2010.

(51) Int. Cl. A23K 1/18

(52) U.S. Cl. 426/1

(57) ABSTRACT

According to various embodiments of the invention, stimulants are provided that result in euphoric behavior in certain animals, such as felines. Specifically, according to one embodiment, the animal stimulant is obtained by a process comprising: growing an actinidia polygama to fruition; increasing a concentration of matatabilactones within fruit of the actinidia polygama; extracting moisture from the fruit; and grounding the fruit into a fine powder. In some embodiments, the animal stimulant is specially tailored for use with feline animals.

### CROSS-REFERENCE TO RELATED APPLICATIONS

This application is a continuation-in-part of and claims the benefit of U.S. patent application Ser. No. 12/712,007, filed Feb. 24, 2010, which is incorporated herein by reference in its entirety.

### FIELD OF THE INVENTION

The present invention relates to feline stimulants, and more particularly, some embodiments relate to recreational substances that stimulate euphoric behavior in felines and methods of manufacturing the same.

### DESCRIPTION OF THE RELATED ART

Nepeta cataria, also known as catnip, is a substance commonly used to induce a feeling of happiness and euphoria in a majority of felines. Under the influence of catnip, cats have been observed to be attracted to the catnip, roll around the ground, and drool.

Actinidia polygama, a plant unrelated to catnip, is known to cause a similar but stronger behavioral response in felines than does catnip. Specifically, both domestic cats and large cats, such as lions, cougars, bobcats and ocelots, have been observed exhibiting large euphoric responses to actinidia polygama. In Asia, it is known to use actinidia polygama as a cat treat and even a human wellness product. However, until now, the parts of the actinidia polygama that have been used have been limited to stems, leaves, and fruit left untouched by insects.

### BRIEF SUMMARY OF EMBODIMENTS OF THE INVENTION

According to various embodiments of the invention, animal stimulants based on actinidia polygama are provided that result in a strong euphoric response in certain animals, such as felines. Specifically, according to one embodiment, the animal stimulant is obtained by a process comprising: growing an actinidia polygama to fruition; increasing concentration of matatabilactones within fruit of the actinidia polygama; extracting moisture from the fruit; and grounding the fruit into a line powder. In some embodiments, the animal stimulant is specially tailored for use with feline animals. In addition, for some embodiments, the extraction of moisture from the fruit leaves the fruit with a moisture content of 10% to 12%.

Depending on the embodiment, increasing concentration of matatabilactones may be facilitated by exposing the fruit of the actinidia polygama to an asphondylia matatabi (commonly referred to as gall midges or gall gnats) that attack the fruit, thereby causing matatabilcatones in the fruit to increase in concentration. Additionally, in some embodiments, extracting moisture from the fruit may entail kiln drying the fruit. Once dried, in further embodiments, the fruit can be grounded into a fine powder of 80 mesh or liner. For example, in some embodiments, the grind size may be between 10 mesh and 80 mesh.

In additional embodiments, the fine powder may be applied to an animal toy or feral cat bait. For example, the fine powder may be coated on the animal toy or feral cat bait. In further embodiments, the fine powder may be developed into a salve, typically used for veterinary applications, or an animal dietary supplement. More with regard to applications of this invention will be discussed later in the detailed description.

In further embodiments, the animal stimulant is obtained by a process comprising: extracting moisture from fruit of an actinidia polygama, wherein the fruit has an increased concentration of matatabilactones; extracting moisture from green leaves of an actinidia polygama; grounding the green leaves into a leaf powder; grounding the fruit into a fruit powder; and mixing the leaf powder with the fruit powder, thereby producing a mixture. In some such embodiments, extracting moisture from the leaves comprises drying and dehydrating the leaves. In other embodiments, mixing the leaf powder with the fruit powder comprises mixing the leaf powder with the fruit powder at a ratio of 1:10. In additional embodiments, the leaf powder has a grind size of 2 mm or less. For example, in some embodiments, the leaf powder may have a grind size between 0.1 mm and 2 mm.

Other embodiments include methods for manufacturing animal stimulants and animal medicaments in accordance with various operations provided above.

Other features and aspects of the invention will become apparent the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The present invention, in accordance with one or more various embodiments, is described in detail with reference to the following figure. The drawing is provided for purposes of illustration only and merely depict typical or example embodiments of the invention. This drawing is provided to facilitate the reader's understanding of the invention and shall not be considered limiting of the breadth, scope, or applicability of the invention.

FIG. 1 is flowchart illustrating an example method in accordance with one embodiment of the invention.

FIG. 2 is flowchart illustrating an example method in accordance with one embodiment of the invention.

This figure is not intended to be exhaustive or to limit the invention to the precise form disclosed. It should be understood that the invention can be practiced with modification and alteration, and that the invention be limited only by the claims and the equivalents thereof.

### DETAILED DESCRIPTION OF THE EMBODIMENTS OF THE INVENTION

The present invention is directed toward a feline stimulant and methods of manufacturing the same. In particular, the feline stimulant in accordance with embodiments of the invention is derived from the actinidia polygama plant, and results in a strong behavioral response from felines. Behavioral responses for some embodiments include the feelings of euphoria and relaxation. The types of felines susceptible to the stimulants effect include both domestic cats and larger cats, such as lions, cougars, bobcats and ocelots.

Stimulants created in accordance with the present invention can be utilized in a variety of applications including, but not limited to, olfactory stimulation for captive animals (e.g., in zoos or shelters), products that increase reproductive success, appetite stimulant, anti-anxiety product for domestic cats, coatings used for animal toys, animal bait (e.g., feral cat bait), sprays for felines, incense for felines, training aids, and veterinary uses, such as dietary wellness products. For example, a stimulant in accordance with the present invention may be developed into a salve that can be applied to the fur of a sick feline. Once applied, the sick feline can then lick off the salve from its fur, thereby receiving a dose of the stimulant and causing the sick feline to have an increased appetite.

With respect to applications for olfactory stimulation, enclosures do not offer animals such as felines sufficient mental and physical stimuli to occupy most of their activity time. Captive animals may show abnormal behaviors, such as boredom, aggression to people and to rats fearfulness, anorexia, tail-chasing, stereotypies, fabric eating and even self-mutilation. Certain embodiments of the present invention provide sense enrichment of felines through the olfactory system. With olfactory stimulation, such embodiments increase naturalistic behavior, enhances enclosure exploration, increases species-typical behavior, reduces inactivity, and undesirable behavior such as stereotypy.

As another application, certain embodiments may be used in products meant to increase reproductive success. One behavior problem that occurs with large cats in captivity is poor reproductive success. These embodiments meant for reproductive success can be introduced as a stimulus that encourages natural behaviors and interactions between conspecifics. Such embodiments can be used to increase behaviors related to exploration, including sensory investigation and locomotion in exotics and domestic cats.

For veterinary uses, some embodiments can be used as appetite stimulants. For cats that refuse to eat, such embodiments may be used in a small amount near the cat's food. The cat, if responsive to the stimulant, will exhibit increased behavior and then start eating. Typically when a cat refuses to eat due to a number of reasons, including stress or trauma of new environment, the veterinarian may have to insert a feeding tube to give nutrition to the cat, thereby further traumatizing the cat. Using such appetite stimulant embodiments reduces the trauma to the cat and gets it back to feeding. Additionally, use of such embodiments has the added benefit of reducing the cost per animal the shelter has to spend on medical supplies and veterinary expense.

For veterinary uses, some embodiments can be used as anti-anxiety applications. For example, certain anti-anxiety embodiments for domestic cats in shelters can provide such cats with relief from stress. Such embodiments may be provided in the form of a powder, incense, or hard breakaway bait.

With respect to cat toys and accessories, certain embodiments may be added within toy mice for cats. The product may be a coarse grind and glued to the inside of the toy mice with non-toxic rice paste. The toy may be covered with a breathable material such as fleece so the scent of the blend can be released. Similarly, other embodiments may be applied to cat toy pillows.

Some embodiments may be applied to exotic cat toys, such as large animal bones, or domestic cat toys. For example, for large animal bones, the embodiment can be blended into a non-toxic carrier, such beeswax or some other hard wax, and the carrier can then hard compressed into the shape of a hone.

Further embodiments may be used to fabricate cat toys. For example, dried sections of actinidia polygama can be wound in shapes, such as balls, that can be used as toys for cats. The size of shapes can vary from 1″ to 12″.

Other embodiments may be infused, in powdered form, onto scratchers for cats or, alternatively, made available for application to existing scratchers. Such embodiments would attract the cat to the scratcher and, thereby, make it more effective. Likewise, embodiments may be infused into a cat bed or litter box to attract the cat to the bed or box respectively. Depending on the application, the embodiment for cat beds may be infused into a changeable powder pouch, sewn into the bed, or applied by a sprayer.

Certain embodiments may be incorporated into a spray for cats. For example, a fine powder of the embodiment may be suspended into a mixture of purified water. Such solutions could be placed into a bottle having an atomizer cap capable of spraying the solution onto various surfaces. When the water evaporates, a thin coating of the embodiment would remain on the surface.

Various embodiments may be used in incense for cats. The embodiment may be mixed with compounds, such as non toxic slow combustion, that are typically used in the manufacture of incense. Such an incense product could be used to attract or relieve the stress of cats, and do so over a number of rooms within a building.

Further embodiments may be used in training aids, where the embodiments may be infused with, or sewn inside, a small cloth pouch (e.g., 1″-3″ in size) used as a treat when training a cat.

A variety of embodiments may be used as bait for feral cat. For example, the embodiments may be mold shaped process into a custom shaped rectangular bar—like a chocolate bar—that has small breakaway squares. These break away squares can then be used in traps.

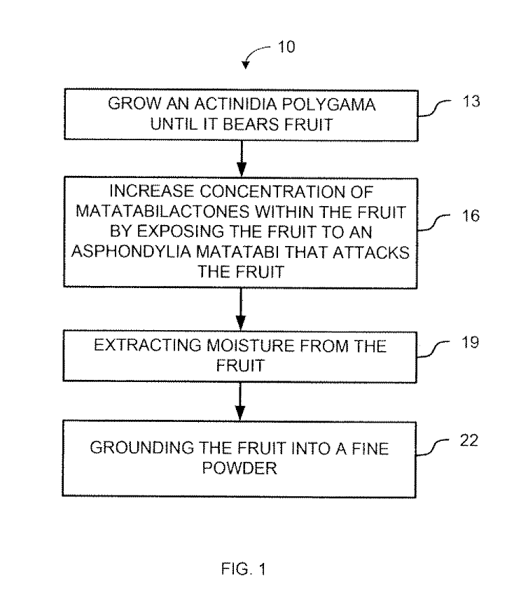

FIG. 1 provides a flowchart of an example method 10 for obtaining animal stimulant in accordance with one embodiment of the invention. Referring now to FIG. 1, method 10 begins at operation 13 with the growth of an actinidia polygama until it bears fruit. The fruit of an actinidia polygama (also known as silver vine) is a large berry. Next, during operation 16, the fruit of the actinidia polygama is exposed to at least one fly from the species of asphondylia matatabi. During this exposure, the fruit is attacked by the asphondylia matatabi (also known as a gall midge or gall gnat), thereby resulting in an increase of matatabilactones within the fruit. One of ordinary skill in the art would understand and appreciate that other methods exist for increasing the matatabilactones within the fruit produced by the actinidia polygama, and that such method are within the scope of the present invention.

Subsequently, after the fruit has been gathered from the actinidia polygama, in operation 19, moisture is extracted from the fruit in order to dry the fruit to a predetermined moisture concentration. For example, in some embodiments, the predetermined moisture concentration is between 10% and 12%. Methods for extracting moisture from the fruit include kiln drying. One of ordinary skill in the art would understand and appreciate that other conventional methods for extracting moisture can be utilized to achieve the predetermined moisture concentration without departing from the scope of the present invention.

After the fruit has been adequately dried, the fruit is ground into a fine powder in operation 22. In some embodiments, a powder of 80 mesh is utilized. In further embodiments, powder of having a finer mesh (e.g., 120 mesh, 220 mesh, etc.) may be employed. Once in powder form, the stimulant is ready to be utilized in a variety of applications such as coatings used for animal toys or animal bait (e.g., feral cat bait), as well as veterinary uses such as dietary wellness products, salves and medication.

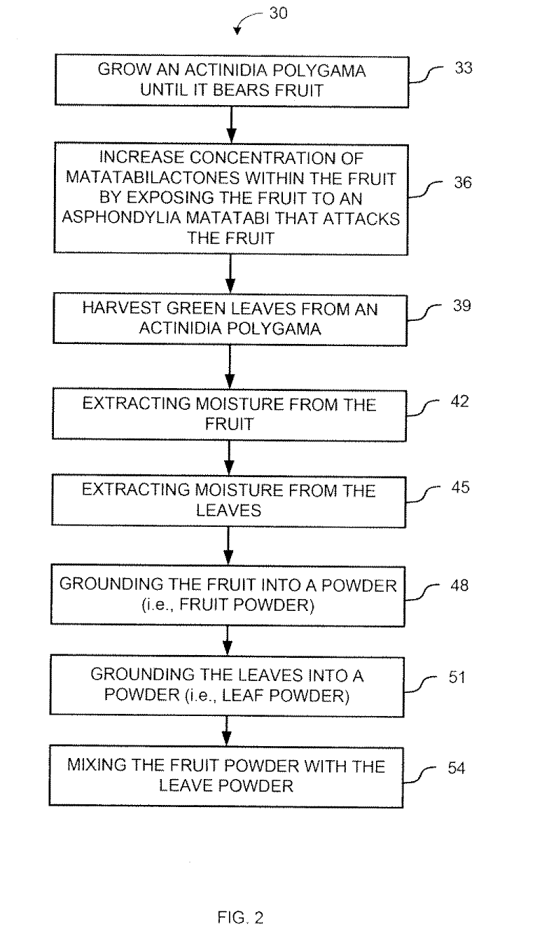

FIG. 2 provides a flowchart of an example method 30 for obtaining animal stimulant in accordance with one embodiment of the invention. Similar to FIG. 1, method 30 of FIG. 2 begins at operation 33 with the growth of an actinidia polygama until it bears bruit. Then, in operation 36, the fruit of the actinidia polygama is exposed to at least one fly from the species of asphondylia matatabi, which results in the fly attacking the fruit and increasing the matatabilactones within the fruit. Additionally, in operation 39, once sufficiently mature, the green leaves of an actinidia polygama are harvested for use in the stimulant.

In operation 42, moisture is extracted from the fruit in order to dry the fruit to a predetermined moisture concentration. As noted above, in some embodiments, the predetermined moisture concentration is between 10% and 12%. Following operation 42 is operation 45, where the moisture from the green leaves is extracted to dry the leaves to a predetermined moisture concentration, thereby resulting in dehydrated leaves. One of ordinary skill in the art would understand and appreciate that other conventional methods for extracting moisture can be utilized with either the fruit or leaves to achieve the predetermined moisture concentration without departing from the scope of the present invention.

After the fruit and the leaves has been adequately dried, the fruit is ground into a powder (i.e., fruit powder) in operation 48, and the leaves are ground into a powder (i.e., leaf powder) in operation 51. In some embodiments, a powder of 80 mesh is utilized for the fruit powder. For example, the powder may have a grain size between 10 mesh and 80 mesh. In further embodiments, powder of having a finer mesh (e.g., 120 mesh, 220 mesh, etc.) may be employed. In other embodiments, a powder of 2 mm is utilized for the leaf powder. For example, the leaf powder may have a grain size between 0.1 min. and 2 mm.

In Operation 54, the fruit powder and the leaf powder of operations 48 and 51, respectively, are mixed together, resulting in an animal stimulant mixture. In some embodiments, such as the one illustrated, the powders are mixed in predetermined portions. For example, in various embodiments, the mixture comprises of one (1) part leaf powder for every ten (10) parts of fruit powder, thereby resulting in a 1:10 mixture ratio. Additionally, a predetermined mixture ratio used in conjunction with predetermined grain sizes for the powders may result in a mixture that demonstrates heightened animal stimulation among certain animals. For example, with felines, a mixture ratio of leaf powder to fruit powder is 1:10, where the leaf powder has a grain size of 1 mm or less and the fruit powder has a grain size between 60 and 80 mesh, has shown to be effective at animal stimulation. Another effective example for felines is a similar mixture ratio of 1:10 of leaf powder to fruit powder, where the leaf powder has a grain size of 1 mm or less but the fruit powder has a grain size between 10 mesh.

Once mixing is complete, the resulting mixture is ready to be utilized in a variety of applications listed herein, including but in no way limited to coatings used for animal toys or animal bait (e.g., feral cat bait), and veterinary uses such as dietary wellness products, salves and medication.

While various embodiments of the present invention have been described above, it should be understood that they have been presented by way of example only, and not of limitation. Likewise, the various diagrams may depict an example architectural or other configuration for the invention, which is done to aid in understanding the features and functionality that can be included in the invention. The invention is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present invention. Also, a multitude of different constituent module names other than those depicted herein can be applied to the various partitions. Additionally, with regard to flow diagrams operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the ter “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. An animal medicament, comprising:
a stimulant comprising fruit from an actinidia polygama,
wherein the fruit has been attacked by an asphondylia matatabi fly, thereby increasing a matatabilactones concentration within the fruit,
wherein the fruit has a water content of 10% to 12%, and
wherein the fruit is ground to a powder having a grind size of 80 mesh or less.

2. The animal medicament of claim 1, wherein the grind size is between 10 mesh and 80 mesh.

3. An animal stimulant obtained by a process, the process comprising:
extracting moisture from fruit of an actinidia polygama, wherein the fruit has an increased concentration of matatabilactones;
extracting moisture from green leaves of an actinidia polygama;
grounding the green leaves into a leaf powder;
grounding the fruit into a fruit powder; and
mixing the leaf powder with the fruit powder, thereby producing a mixture.

4. The animal stimulant of claim 3, wherein exposing the fruit to an asphondylia matatabi fly that attacks the fruit causes the increased concentration of matatabilactones in the fruit.

5. The animal stimulant of claim 3, wherein extracting moisture from the fruit causes the fruit to have a moisture content of 10% to 127%.

6. The animal stimulant of claim 3, wherein the fruit powder has a grind size of 80 mesh or less.

7. The animal stimulant of claim 3, wherein the grind size is between 10 mesh and 80 mesh.

8. The animal stimulant of claim 3, wherein the powder has a grind size of 2 mm or less.

9. The animal stimulant of claim 8, wherein the grind size is between 0.1 mm and 2 mm.

10. The animal stimulant of claim 3, wherein the animal stimulant is tailored to stimulate a feline.

11. The animal stimulant of claim 3, wherein the mixture is applied to an animal toy or feral cat bait.

12. The animal stimulant of claim 3, wherein the mixture is developed into a salve or an animal dietary supplement.

13. The animal stimulant of claim 3, wherein mixing the leaf powder with the fruit powder comprises mixing the leaf powder with the fruit powder at a ratio of 1:10.

14. A method for creating an animal stimulant, comprising:
extracting moisture from fruit of an actinidia polygama wherein the fruit has an increased concentration of matatabilactones;
extracting moisture from green leaves of an actinidia polygama;
grounding the green leaves into a leaf powder;
grounding the fruit into a fruit powder; and
mixing the leaf powder with the fruit powder, thereby producing a mixture.

15. The method of claim 14, wherein increasing the concentration of matatabilactones comprises exposing the fruit of the actinidia polygama to an asphondylia matatabi fly that attacks the fruit, thereby causing the increased concentration of matatabilactones in the fruit.

16. The method of claim 14, wherein extracting moisture from the fruit causes the fruit to have a moisture content of 10% to 12%.

17. The method of claim 14, wherein the fruit powder has a grind size of 80 mesh or less.

18. The method of claim 17, wherein the grind size is between 10 mesh and 80 mesh.

19. The method of claim 14, wherein the leaf powder has a grind size of 2 mm or less.

20. The method of claim 19, wherein the grind size is between 0.1 mm and 2 mm.

21. The method of claim 14, further comprising applying the mixture to an animal toy or a feral cat bait with the mixture.

22. The method of claim 14, further comprising developing the mixture into a salve or an animal dietary supplement.
